(19) United States
(12) Patent Application Publication
(10) Pub. No.: US 2009/0048855 A1
(43) Pub. Date: Feb. 19, 2009

(54) Distribution System for Data of a Service

(75) Inventors: Rainer Falk, Erding (DE); Michael Finkenzeller, Muenchen (DE); Stephanie Genety, Muenchen (DE); Christoph Hielscher, Muenchen (DE); Stefan Jenzowsky, Muenchen (DE); Hubert Jaeger, Pullach (DE); Gerta Koester, Muenchen (DE)

Correspondence Address: BELL, BOYD & LLOYD, LLP, P.O. BOX 1135, CHICAGO, IL, 60690, US

(73) Assignee: NOKIA SIEMENS NETWORKS GMBH & CO. KG, MUNICH (DE)

(21) Appl. No.: 11/884,295

(22) PCT Filed: Feb. 9, 2006
(86) PCT No.: PCT/EP06/50791

§ 371 Date: May 28, 2008

(30) Foreign Application Priority Data
Feb. 18, 2005 (DE) 10 2005 007 604.1

(51) Int. Cl. G06Q 30/00; H04L 9/00

(52) U.S. Cl. 705/1; 726/1

(57) ABSTRACT

A distribution system for providing data of at least one service between a first network unit and at least one second network unit over a communication network includes a receiver unit and a transmitter unit in the first network unit, and a processing unit in the first network unit. The processing unit is configured to compare a request to provide data of at least one service by the at least one second network unit with at least one stored policy, and to transmit the requested data of at least one service as a function of the comparison result to the at least one second network unit. The system includes further at least one memory unit configured to store the at least one policy and the data of a service.

Providers of so called “contents” or data of a service, such as music, films, games etc. are faced with considerable losses arising from pirated copies and their distribution. Previous approaches to the problem, such as Digital Rights Management (DRM) principally operate on the basis of using protection mechanisms to prevent the copy being made or the copied content being distributed. This is mostly achieved by suitable copy protection mechanisms or by linking content to specific media players for example. Threats of legal action are also being tried. Thus executable programs (software), music tracks, films etc. are frequently given so-called electronic watermarks for marking, so that illegal use or illegal distribution can be detected and traced back to the instigator. Digital Rights Management (DRM) aims not to make the loss of value of content any greater than with classic distribution, such as via CDs via music shops for example. This results in sometimes very restrictive protection measures which also impinge on the statutory rights of the buyer of the contents and the creator of private contents. At the same time the impetus to bypass the protection measures is very great. Under the premise that any code can be “cracked”—often seen as a type of sport by hackers—a competition arises between ever greater protection measures and the next method of bypassing these measures.

The object of the invention is to propose a simple and cost-effective method for provision of data of a service.

The inventive object is achieved in each case by the subject matter of the independent claims. Further developments of the invention are specified in the subclaims.

A core of the invention is to be seen as, when a request is made to a first network unit for the provision of data of at least one service by at least one second network unit, at least one parameter contained in the request is compared with at least one stored policy. Thereafter the data of the at least one service is transmitted depending on the result of the comparison to the at least one second network unit.

With a distribution system of this type two fundamentally different options can be pursued:

The owner or provider of the data of at least one service is generally concerned about his contents, i.e. the data at least one service, being distributed to as many users as possible. Reasons for this can be:
Advertising for the contents. For musicians wishing to increase the sales of concert tickets, audio media T-shirts etc. for example. The financing can be undertaken in such cases via additional contents embedded in the content such as for example advertising, questionnaires, prize draws etc.
Financing by recording of information. Thus for example the content can be used by a user if he has previously set up a user profile by completing a questionnaire for example.
Financing through additional business involving payment, for example by a link to a “book of the film” in an online shop (Internet shop).

On the other hand it can be negative for a user of data of at least one service to have content personalized for him appearing in Internet exchanges, because his e-mail address is embedded in the content for example. Precisely this information can be misused by so-called spammers for example.

The basic idea behind the invention lies in the assumption that the content provider with a first network unit himself wishes as many users as possible with at least one second network unit to distribute his content, and to do this via unchecked distribution channels such P2P sharing for example. The profit of content providers is example no longer to be obtained by paying for the content but by paying for its distribution and convenient “provision”. A key feature here is the intentional used of the personal distribution channels (for example “the dark net, sneaker net”) of a user instead of the suppression of the provision of data of at least one service (content). Personal distribution channels are often so-called “peer-to-peer” connections between users. Classically (“sneeker net”) this means that manual exchange of data media, in a more modern version it involves data transmission via connected network units (peers in the Internet).

The invention starts from the knowledge that the distributor of content (raw copier) with his at least one second network unit can provide a service using his own resources which the owner of the content or the content provider then does not have to provide. Previously a pirate copier has provided this service illegally and has obtained no reward or a likewise illegal small reward for it. The object of using the inventive method is to deliberately include the “pirate copier” in the inventive distribution system, via which he then legally distributes data of at least one service. The impetus to do this can be for the following reasons:
Low costs for the distributor
Convenient use for the distributor
Low costs for the receiver/user of the content
Convenient availability for the user of the content.

Policies can be created for these triggers and stored in the first network unit. For a request from at least one second network unit the method in accordance with the invention can be applied by comparison with at least one parameter in the request. Naturally further policies, such as the type of copy protection, details for billing etc. can be used.

Using the inventive method produces the following advantages:
Cost-effective, rapid and targeted distribution of content
Cost-savings by dispensing with unnecessarily high protective measures and processes
No loss of image for the content provider as a result of crude intrusion into the copying rights of average users.

The invention aims to reduce the costs of distribution by utilizing personal distribution channels and issuing triggers so that a distribution of data of least one service is able to be performed in a controlled manner.

In addition it is possible with the inventive method to give providers a better opportunity for profit through a fast distribution and a fast publicizing of the data of at least one service. Fast dissemination or fast publicizing enables further products (sales of concert tickets, merchandising, sales of information about usage, T-shirts etc.), to be sold and can thus be of great interest to new, small, private etc. providers (for example new media creators, a new music label). A network operator (carrier) who either operates as a content provider or offers a solution for a content provider would also benefit from using the inventive method as a result of their distribution networks (distribution of the content, distributed personalization) and a contractual relationship with many users (billing).

The invention is explained in greater detail on the basis of an exemplary embodiment shown in a figure. The figures show

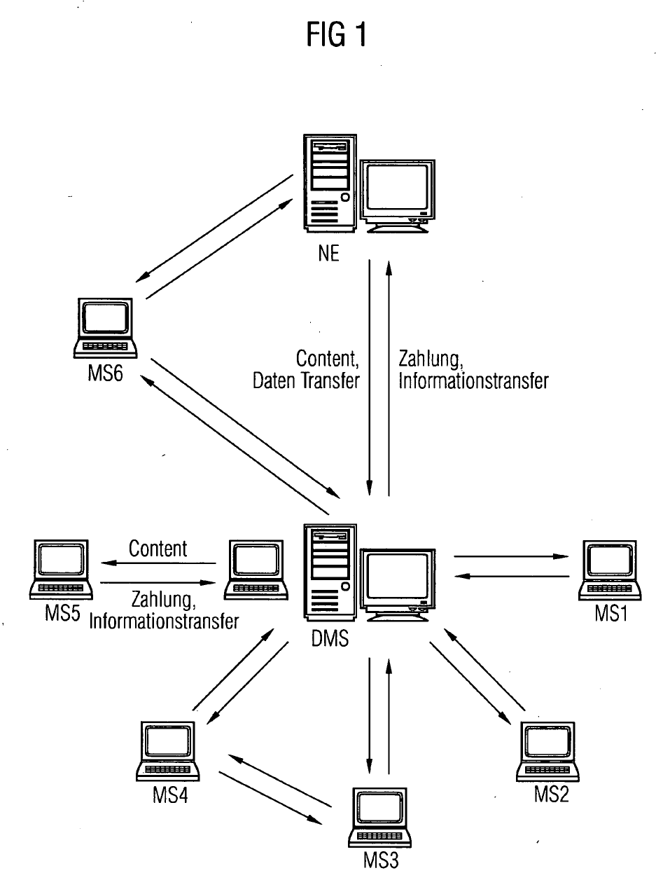

FIG. 1 an inventive distribution system,

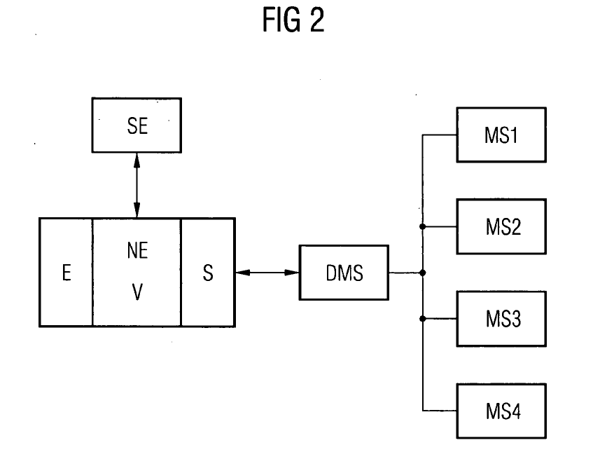

FIG. 2 a simplified architecture of the inventive distribution system.

FIG. 1 shows an inventive distribution system and consists of the following components:
A first network unit NE, such as a server, from which the data of at least one service (contents) can be downloaded.
An administration unit V, which traces the loading of the data of the at least one service and processes a request by at least one second network unit DMS, MS1, MS2, MS3 MS4, MS5, MS6. The at least one second network unit ((DMS, MS1, MS2, MS3, MS4, MS5, MS6) can in this case be a Mobile Station (MS), a computer, a mobile computer, a mobile organizer etc. The administration unit V can for example be a network unit of the first network unit NE.
A memory unit SP which is connected to the first network unit NE, with at least one stored policy and/or stored data of at least one service. The payment for the data of at least on service can be controlled for example with the aid of the at least one policy. However a minimum protection mechanism—somewhat in the sense of a “small bicycle lock” for example—can be taken into account with the aid of at least one policy on provision of the data of at least one service. Thus for example the protection mechanism can be selected so that the “cracking of the protection” is minimally inconvenient for the mass of users. This means that the users could be prepared to make a small contribution or as distributors (resellers of the contents) to pass on profits from the sales to the provider. Naturally anyone “cracking” the protection mechanism however should not gain any cost benefit over an honest user by doing so. The protection mechanism can for example consist of components on a network unit, such as on a server for example, and components which are embedded into the content.

The distribution system generally consists of network units NE, DMS, MS1, MS2, MS3, MS4, MS5, MS6 in a communication network (for example peers in the Internet). A communication network can in this case be an IP network, a cellular mobile radio network, a packet-switching communication network etc.

Three typical situations for the inventive method will be outlined below:

### EXAMPLE 1

A content provider provides data of at least one service for downloading via a first network unit NE in the Internet for example. Data of at least one service can in this case be pictures, text, sound sequences, music, videos, executable programs etc.

Users with at least one second network unit DMS, MS1, MS2, MS3, MS4, MS5, MS6 have access to the first network unit NE via the Internet, provided they have a networked second network unit DMS, MS1, MS2, MS3, MS4, MS5, MS6 available. The at least one second network unit DMS, MS1, MS2, MS3, MS4, MS5, MS6 can in this case be a mobile station, a computer, a mobile computer, a mobile organizer etc. Users of the at least one second network unit DMS, MS1, MS2, MS3, MS4, MS5, MS6 are identified to the first network unit NE. for example using a password and for example using a virtual identity such as a self-chosen pseudonym. Parallel identities can in such cases be prevented either by linking them to a real user identity (trusted user), or via a warning. For a request from the at least one second network unit DMS, MS1, MS2, MS3, MS4, MS5, MS6 regarding the provision of data of least one service, at least one policy is compared with at least one parameter from the request. A policy could state for example that the first ten downloads of data of a service are free. Further downloads cost between 0 euros and x euros. With x being a number. Users wishing to download data of at least one service via the at least one second network unit DMS, MS1, MS2, MS3, MS4, MS5, MS6, then simply pay from 0 euros to x euros per download (downloading of content). Distributors with a second network unit DMS (Distribution Mobile Station), i.e. users, wishing to resell to other users the data of the at least one service, can sell on the data of at least one service with a small surcharge and can for example additionally offer the service of burning the data of at least one service onto a data medium. For such multipliers or distributors corresponding policies, such a special billing for the data of at least one service, credits or other reductions can be defined, which are taken into account by the first network unit NE. Loyalty bonuses for users who frequently have data of a service provided to them are also conceivable. Further policies could also define an evaluation system for the users of the distribution system. For example a link (reference) supplied with the content could be used on an evaluation form by the user to evaluate a distributor. In such cases the side effect can occur that there is a binding of users to the distribution system, since for example distributors with their virtual identities are more attractive for other users if these distributors have a high number of positive evaluations.

Attractiveness means here that the likelihood that use will be made of service of a distributor increases with the number of positive evaluations. A further policy could also state for example that subsequent copies of the data of at least one service deliberately have a “weak” copy protection. The aim is not the invulnerability of the protection. “Cracking” must merely be more difficult than legal acquisition.

A possible scenario could look something like this:
Subsequent copies of the contents are able to be freely created, but are of lower quality or can only be played once before they have to be “released” by a key.
When the contents are copied a personal “lock” and a key number for the copy is created.
The key number and how the user can buy the key are notified to the user when the data of at least one further service is played. This data of at least one further service can represent a part of the contents.
For a distributor, also acquiring the keys for subsequent copies on purchasing the contents from the provider could be defined as a policy for example which he creates, and thus allows release for his customers.

### EXAMPLE 2

A content provider offers for downloading via a first network unit NE in a communication network (Internet) data of at least one service.

Users with at least one second network unit DMS, MS1, MS2, MS3, MS4, MS5, MS6, have access to the first network unit via the communication network, provided they have a networked second network unit available. For a request from the at least one second network unit DMS, MS1, MS2, MS3, MS4, MS5, MS6 regarding the provision of data of least one service, at least one policy is compared with at least one parameter from the request, and thereafter in accordance with the at least one policy the data of at least one service of the at least one second network is provided. In this example a stored policy could state that users of the service must pay for each download by providing information (for example a questionnaire—variable depending on the requested content).

### EXAMPLE 3

This example makes it possible for a content provider to add to the actual content (data of at least one service), additional functions (further data of at least one further service) via which he finances his business. In a similar way to classical DRM systems (DRM=Digitals Rights Management), assumptions are made about the trustworthiness of the client platform or the player device, so that the additional functions can also actually be executed. Furthermore the further data of the at least one further service should not simply be able to be removed. Additional functions are for example further data of at least one further service, which is played before the data required by the user of the at least one service.

This is achieved by further data of at least one further service of the following type:
Advertising (non-interruptible under some circumstances). “Active advertising”, which requires a user interaction (so that the advertising does not run in the background, without the user actually seeing it), could also be used. The promotion can even be a small game (e.g. a flash application) which is intended to entertain the user (in the foreground), but company logos, products are skillfully included in the action.
Questionnaires, for example embedded HTML forms, which are transmitted via the http protocol to the first network unit NE; only once the user has filled out his questionnaire can he play the actual content.
Tracking information: A URL address must be called up. This makes it possible to trace how often the data of at least one service (especially the advertising) has been viewed. Under some circumstances this is problematic from the point of view of data protection, precisely like the tracing of user-related data (this would allow conclusions to be drawn about what content a specific user is viewing). A cookie could be used for this for example, so that the user can be traced or monitored. The URL address could in this case be called up only for tracking for example, or a browser window can automatically open to display a corresponding page with advertising and/or an HTML form (for example a questionnaire).
URL addresses at Internet shops (online shops) (additional products: buy CD, book of the film, poster, . . . ) could also be traced.

The additional functions which have already been called up can possibly also be stored locally (as with a cookie for Web browsers). User acceptance can be increased in this way: The user only then has to look at advertising once for example; if he looks at the content a further time he can then access the actual desired content.

Furthermore variants of the defined policies are of course conceivable, so that after frequent calling up, an additional function or further data of at least one further service once again appears or appear automatically or in general that the additional functions (for advertising etc.) are only displayed automatically after repeated calling up. In general this can be implemented by a policy. This is part of the contents and defines how the player in the at least one second network unit DMS, MS1, MS2, MS3, MS4, MS5, MS6 has to deal with the further data of at least one further service.

Content can consist of a number of parts with dependencies regarding the display and of the playing of the content: Only if content parts of the first type are played (advertising, questionnaire, Web page), is the player in at least one second network unit DMS, MS1, MS2, MS3, MS4, MS5, MS6 ready to also display/play the other parts (the actual film, the actual piece of music).

Further policies allow the content to be (visibly) personalized and individualized. This enables the restriction threshold for “unchecked” passing on of content to be increased (worries about legal consequences for the user, wish to remain anonymous, protection against disproportionate e-mail spam, if the e-mail address of the user is embedded into the personalized content etc.).

Within the framework of the inventive method the personalization/individualization of the contents can be undertaken with the request relating to the provision of the content by the first network unit NE.

Possible variants of this at least one policy for personalization/individualization of the content could be:
Visual display of personal data (name, . . . ) in videos for example.
Audible inclusion of personal data (name, . . . ) in videos for example.

FIG. 3 shows a simplified architecture of an inventive distribution system. A first network unit NE possesses a receiver unit E, a processing unit V and a transmitter unit S. For a request via the receiver unit E of the first network unit NE, relating to the provision of data of at least one service from at least one second network unit DMS, MS1, MS2, MS3, MS4, the processing unit V for example in the first network unit NE compares at least one parameter contained in the request with at least one stored policy. The user name, identification number, telephone number and further information relevant for the first network unit NE count as parameters. Depending on the comparison result the processing unit V makes available via the transmitter unit S to the at least one second network unit DMS, MS1, MS2, MS3, MS4 the requested data of the at least one service. The at least one policy as well as the data of the at least one service are stored in one or more memory units. A memory unit SE can be a table, a database etc. Thus for example the data of at least one service could be billed in accordance with at least one policy made available to the at least one second network unit DMS, MS1, MS2, MS3, MS4, if the at least one second network unit DMS, MS1, MS2, MS3, MS4 involves a reseller with a distribution network DMS. In this case a distribution network unit (at least one second network unit) can be a mobile station, a computer, a mobile computer, a mobile organizer etc. The distribution network unit DMS can then if necessary transmit the data of at least one service to further network units MS1, MS2, MS3, MS4 and thus a distribution system is produced.

1.-13. (canceled)

14. A method for providing data of at least one service between a first network unit and at least one second network unit via a communication network, comprising:
in response to a request for providing data of at least one service by the at least one second network unit, comparing by the first network unit at least one parameter contained in the request with at least one stored policy; and
transmitting the requested data of at least one service to the at least one second network unit, depending on a result of said comparing.

15. The method of claim 14, further comprising determining by the first network unit a protection mechanism to be used in relation to using data for said data of a service as a function of the at least one stored policy.

16. The method of claim 14, further comprising adding further data of a further service, which is to be executed by the at least one second network unit before the data of a service is used, to the data of a service depending on at least one policy.

17. The method of claim 16, wherein the data of the further service includes at least one of text, images, sound sequences, videos and executable programs.

18. The method of claim 14, further comprising billing of the data of a service as a function of at least one policy.

19. The method of claim 14, wherein the data of the service includes at least one of text files, image files, sound sequence files, video files and executable programs.

20. The method of claim 14, further comprising forwarding transmitted data of a service by the at least one second network unit to at least one further network unit.

21. The method of claim 20, further comprising signaling the forwarding of the data of a service through the at least one second network unit to the first network unit in accordance with the at least one policy of the first network unit.

22. The method of claim 14, wherein the at least one second network unit is one of a mobile station, a computer, a mobile computer and a mobile organizer.

23. The method of claim 14, wherein the communication network is one of a cellular mobile radio network, a packet switching communication network and an IP network.

24. A distribution system for providing data of at least one service between a first network unit and at least one second network unit over a communication network, comprising:
a receiver unit and a transmitter unit in the first network unit;
a processing unit in the first network unit configured to compare a request to provide data of at least one service by the at least one second network unit with at least one stored policy, and to transmit the requested data of at least one service as a function of the comparison result to the at least one second network unit; and
at least one memory unit configured to store the at least one policy and the data of a service.

25. The distribution system of claim 24, wherein the processing unit is provided for determining a protection mechanism to be used relating to a use of the data for the data of a service as a function of the at least one policy.

26. The distribution system of claim 24, wherein the processing unit is provided for adding further data of a further service to the data of a service in accordance with the at least one policy, which is to be executed by the at least one second network unit before the data of a service is used.
